(19) United States
(12) Patent Application Publication
(10) Pub. No.: US 2023/0274485 A1
(43) Pub. Date: Aug. 31, 2023

(54) EYES TRACKING SYSTEM, METHOD AND PROGRAM

(71) Applicant: Nippon Telegraph and Telephone Corporation, Tokyo (JP)

(72) Inventors: Motohiro Makiguchi, Musashino-shi, Tokyo (JP); Masanori YOKOYAMA, Musashino-shi, Tokyo (JP); Kimitaka TSUTSUMI, Musashino-shi, Tokyo (JP); Takashi SATO, Musashino-shi, Tokyo (JP)

(21) Appl. No.: 18/018,085

(22) PCT Filed: Jul. 29, 2020
(86) PCT No.: PCT/JP2020/029032

§ 371 Date: Jan. 26, 2023

(51) Int. Cl. G06T 13/40; G06T 19/00; G06F 3/01

(52) U.S. Cl. CPC G06T 13/40; G06T 19/003; G06F 3/013; G06T 2207/30201

(57) ABSTRACT

There is provided a line-of-sight tracking system including a pseudo eyeball model generation device 10 and a display device 20, in which the pseudo eyeball model generation device 10 generates a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking, and the display device 20 displays the pseudo eyeball which is different according to a viewpoint position of the observer based on the pseudo eyeball model.

### TECHNICAL FIELD

The present invention relates to a line-of-sight tracking system, a line-of-sight tracking method, and a program.

### BACKGROUND ART

In communication between persons, a gesture of matching the line of sight with a person facing another is important non-language information. In pictures, signboards, or the like, there is a method of using an illusion using two-layer display surfaces as a classical method for matching the line of sight of a displayed person with an observer at an arbitrary position in a real space.

In this method, a face image and a pupil image are physically divided, and the pupil image is presented on the side behind the face image, so that the observer can have an illusion that the line of sight of the displayed person is directed to the observer irrespective of the location of the observer. Based on this principle, a telepresence robot is disclosed, for example, in Non Patent Literature 1, in which a pseudo eyeball is provided with two kinds of convex and concave shapes, the convex surface is presented when the line of sight is desired to be directed to a specific observer, and the concave surface is presented when the line of sight is desired to be matched with an unspecified observer.

### CITATION LIST

### Non Patent Literature

[NPL 1] [Retrieved on Jul. 15, 2020], Internet <URL: http://dl.acm.org/doi/pdf/10.1145/2909824.3020235>

### SUMMARY OF INVENTION

### Technical Problem

However, the representation of the line of sight is fixed depending on the depth distance of two layers in the classical method and the shape of the pseudo eyeball in the method disclosed in Non Patent Literature 1. In other words, there is a problem that the conventional line-of-sight representation cannot be flexibly performed because it is determined in terms of hardware.

The present invention has been made in view of this problem, and an object of the present invention is to provide a line-of-sight tracking system, a line-of-sight tracking method, and a program that can flexibly perform line-of-sight representation.

### Solution to Problem

A line-of-sight tracking system according to one aspect of the present invention is a line-of-sight tracking system including a pseudo eyeball model generation device and a display device, in which the pseudo eyeball model generation device generates a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking, and the display device displays a pseudo eyeball image representing the pseudo eyeball which is different according to a viewpoint position of the observer based on the pseudo eyeball model.

Further, a line-of-sight tracking method according to one aspect of the present invention is a line-of-sight tracking method performed by the above line-of-sight tracking system, and the method includes: generating, by the pseudo eyeball model generation device, a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking; and displaying, by the display device, a pseudo eyeball image representing the pseudo eyeball which is different according to a viewpoint position of the observer based on the pseudo eyeball model.

Furthermore, a program according to one aspect of the present invention is a program for causing a computer to function as the above line-of-sight tracking system.

### Advantageous Effects of Invention

According to the present invention, the line-of-sight representation can be flexibly performed based on the pseudo eyeball model.

### BRIEF DESCRIPTION OF DRAWINGS

FIG. 1 is a diagram showing an example of a configuration of a line-of-sight tracking system according to an embodiment of the present invention.

FIG. 2 is a diagram schematically showing an example of a configuration of a pseudo eyeball model.

FIG. 3 is a diagram showing a relationship between a type of line-of-sight tracking and a mode of the pseudo eyeball model.

FIG. 4 is a diagram schematically showing a facial expression of a person in the case of excessive line-of-sight tracking and no line-of-sight tracking.

FIG. 5 is a diagram schematically showing an example of another configuration of a pseudo eyeball model.

FIG. 6 is a diagram showing an example of a configuration of a display device according to the embodiment of the present invention.

FIG. 7 is a diagram showing a relationship between a pseudo eyeball model and a viewpoint of an observer.

FIG. 8 is a diagram showing a relationship between the pseudo eyeball and the viewpoint of the observer when the viewpoint of the observer is at an angle.

FIG. 9 shows an example of a relationship between the angle shown in FIG. 8 and a diameter of a pseudo pupil.

FIG. 10 is a flowchart showing a processing procedure of the line-of-sight tracking system shown in FIG. 1.

FIG. 11 is a block diagram showing an example of a configuration of a general-purpose computer system.

### DESCRIPTION OF EMBODIMENTS

An embodiment of the present invention will be described below with reference to the drawings. The same elements in a plurality of drawings are given the same reference numerals in order not to repeat description.

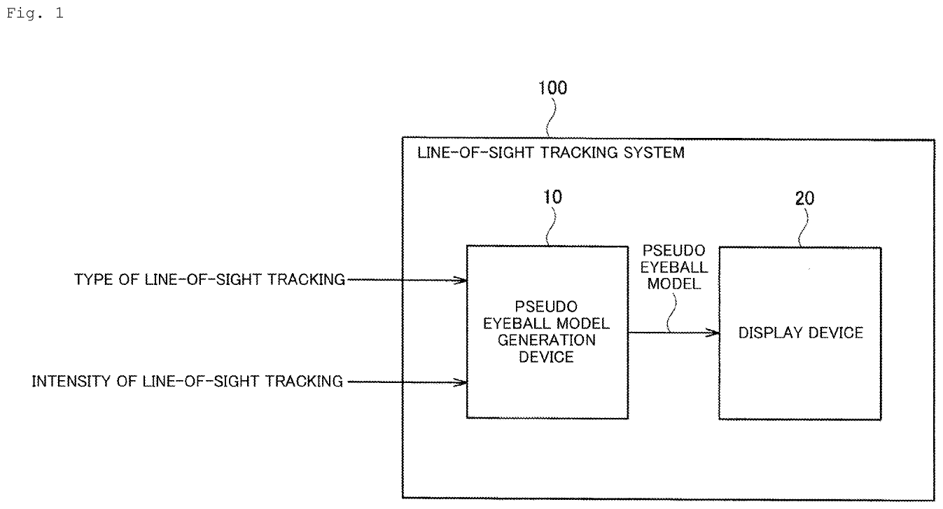

FIG. 1 is a diagram showing an example of a configuration of a line-of-sight tracking system according to an embodiment of the present invention. A line-of-sight tracking system 100 shown in FIG. 1 displays an image for providing the observer with non-language communication information such as matching of the line of sight or deviation of the line of sight.

The line-of-sight tracking system 100 includes a pseudo eyeball model generation device 10 and a display device 20.

The pseudo eyeball model generation device 10 generates a pseudo eyeball model representing a pseudo eyeball with pseudo pupil information, virtual eyeball information indicating a virtual eyeball, and opening information indicating an opening corresponding to an eyelid when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking.

As shown in FIG. 1, information indicating “type of line-of-sight tracking” is given from the outside. “With tracking” is a type of line-of-sight tracking in which the viewpoint of the observer and the viewpoint presented by the line-of-sight tracking system 100 are changed in accordance with each other. In this case, the line-of-sight tracking system 100 provides a line-of-sight representation that is received by the observer as if the state of mind were calm and interested.

The case of “excessive tracking” provides a line-of-sight representation that is received by the observer as if having a slightly excited and strong interest. The excitement includes various emotions such as anger, joy, and sadness.

“Weak tracking” is a type of line-of-sight representation opposite to “excessive tracking.” “Weak tracking” provides a line-of-sight representation that is received by the observer as if being less interested.

The case of “no tracking” provides a line-of-sight representation that is received by the observer as if having no interest. This is a line-of-sight representation called “eyes turn into dots.”

The “intensity of line-of-sight tracking” is given from the outside similarly to the “type of line-of-sight tracking.” The “intensity of line-of-sight tracking” is information indicating the degree of each intensity when the “type of line-of-sight tracking” is “excessive tracking” and “weak tracking.”

(Pseudo Eyeball Model)

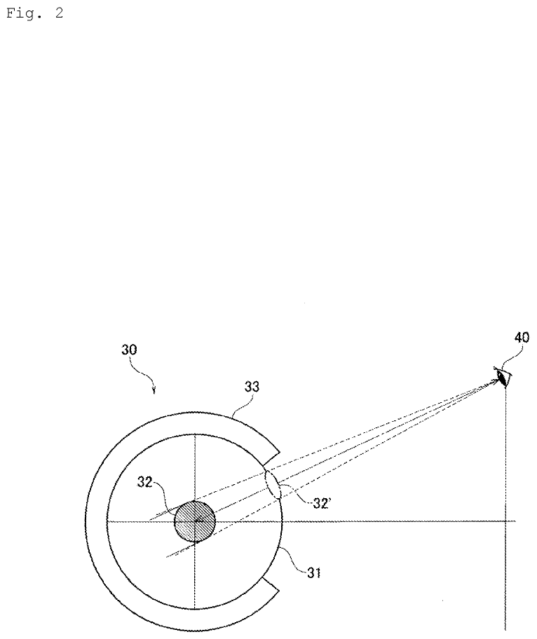

FIG. 2 is a diagram schematically showing an example of a configuration of a pseudo eyeball model.

The pseudo eyeball model 30 shown in FIG. 2 includes virtual eyeball information indicating a virtual eyeball 31, pseudo pupil information indicating a pseudo pupil 32, and opening information indicating an eyelid 33. The virtual eyeball 31 is transparent or translucent, and an observer can visually recognize the pseudo pupil 32 without this being shielded by the virtual eyeball 31.

In FIG. 2, reference numeral 40 denotes a viewpoint of the observer. As shown in FIG. 2, when the pseudo pupil 32 is disposed at the center of the virtual eyeball 31, a viewpoint 40 of the observer and the center of the pseudo pupil 32 are connected by a straight line indicated by an alternate long-and-short dashed line. The viewpoint 40 of the observer and the upper end and the lower end of the pseudo pupil 32 are connected by straight lines indicated by large broken lines, respectively.

In this case, the pseudo pupil 32 can be visually recognized by the observer as if it were located near the upper end of an opening 34 formed by the eyelid 33. Then, the observer perceives that the viewpoint presented by the pseudo eyeball model 30 and his/her own viewpoint match. The position of the pseudo pupil 32 perceived by the observer is represented by an ellipse 32′ indicated by a two-dot dashed line.

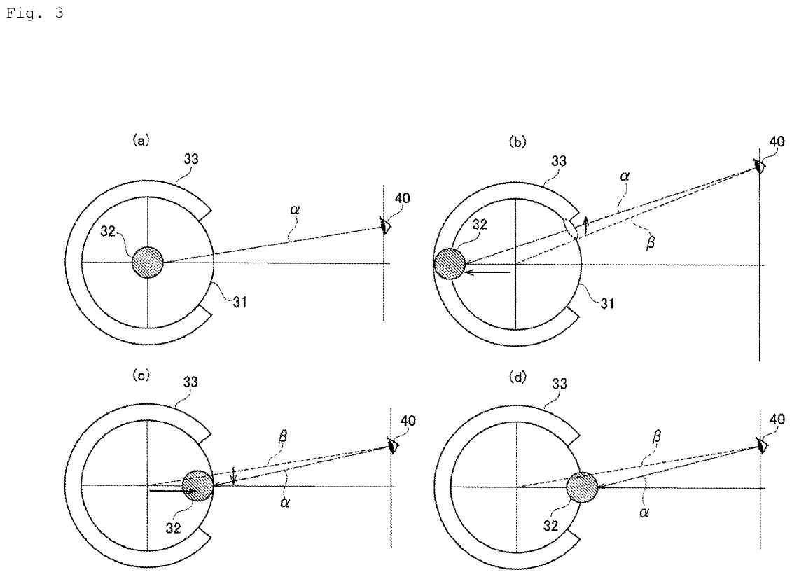

FIG. 3 is a diagram showing a relationship between a type of line-of-sight tracking and a mode of the pseudo eyeball model. FIG. 3 shows an example in which the viewpoint 40 is disposed above or on the right side with respect to the center of the virtual eyeball 31 in order to facilitate the description. The position of the viewpoint 40 may be located on the lower side or the left side. Further, the distance between a horizontal line passing through the center of the virtual eyeball 31 and the viewpoint 40 may be of any size. In other words, the viewpoint 40 can be moved in a direction orthogonal to the horizontal line at an arbitrary position.

FIG. 3(a) shows a pseudo eyeball model in the case where the “type of line-of-sight tracking” is “with tracking.” As shown in FIG. 3(a), when the “type of line-of-sight tracking” is “with tracking,” the center of the pseudo pupil 32 matches the center of the virtual eyeball 31, and a straight line α indicated by an alternate long-and-short dashed line connecting the viewpoint 40 of the observer and the center of the pseudo pupil 32 matches a straight line connecting the viewpoint 40 and the center of the virtual eyeball 31. In this case, the observer feels as if he/her were seen in a pseudo eyeball displayed based on the pseudo eyeball model 30.

FIG. 3(b) shows a pseudo eyeball model in the case where the “type of line-of-sight tracking” is “excessive tracking.” In the case of “excessive tracking,” the center of the pseudo pupil 32 is moved away from the observer on the central axis from the center of the virtual eyeball 31. As shown in FIG. 3(b), the straight line a indicated by the alternate long and short connecting the viewpoint 40 of the observer and the center of the pseudo pupil 32 is located outside a straight line β indicated by a broken line connecting the viewpoint 40 and the center of the virtual eyeball 31. In this case, the observer feels as if a pseudo eyeball displayed based on the pseudo eyeball model 30 were staring at him/her. The center of the pseudo pupil 32 is moved backward from the center of the virtual eyeball 31 when viewed from the observer on the horizontal line passing through the center of the virtual eyeball 31 in correspondence with the intensity of the line-of-sight tracking. The amount of movement is proportional to the intensity of line-of-sight tracking.

FIG. 3(c) is a diagram showing a pseudo eyeball model in the case of “weak tracking.” In the case of “weak tracking,” the center of the pseudo pupil 32 is moved from the center of the virtual eyeball 31 to approach the observer on the central axis. As shown in FIG. 3(c), the straight line α indicated by the alternate long-and-short dashed line connecting the viewpoint 40 of the observer and the center of the pseudo pupil 32 is located inside the straight line β indicated by the broken line connecting the viewpoint 40 and the center of the virtual eyeball 31. In this case, the observer feels that the pseudo eyeball deviates from his or her eyes. The center of the pseudo pupil 32 is moved so as to approach the observer on the horizontal line passing through the center of the virtual eyeball 31 in proportion to the weakness of the line-of-sight tracking.

FIG. 3(d) is a diagram showing a pseudo eyeball model in the case of “no tracking.” In the case of “no tracking,” the center of the pseudo pupil 32 matches the surface of the virtual eyeball 31 on the observer side, for example. As shown in FIG. 3(d), the straight line a indicated by the alternate long-and-short dashed line connecting the viewpoint 40 of the observer and the center of the pseudo pupil 32 is located far inside the straight line β indicated by the broken line connecting the viewpoint 40 and the center of the virtual eyeball 31. In this case, the observer feels a line-of-sight representation called “eyes turn into dots” from the displayed pseudo eyeball.

The display device 20 simultaneously displays a pseudo eyeball image based on the pseudo eyeball model 30 and a face image of a person. The display device 20 will be described in detail later.

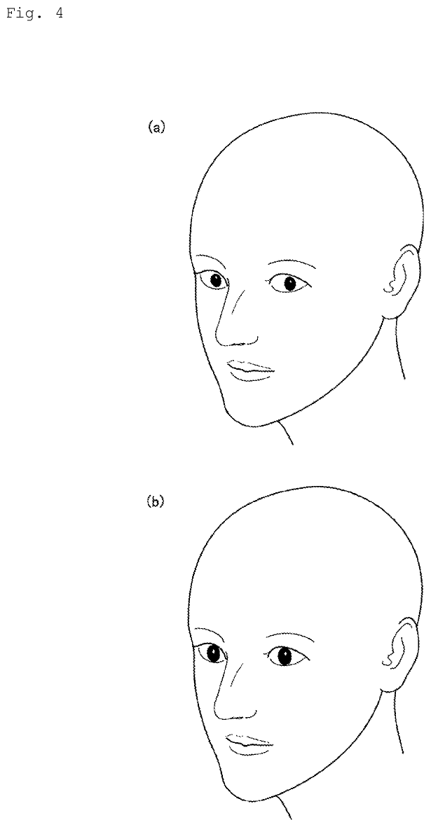

FIG. 4 is a diagram schematically showing a facial expression of a person in the case of “excessive tracking” and “no tracking.” FIG. 4(a) is a diagram showing the pseudo eyeball model 30 and the face image of the person at the same time in the case of “excessive tracking.” FIG. 4(b) is a diagram showing the pseudo eyeball model 30 in the case of no tracking.” The face image of the person is the same in FIGS. 4(a) and 4(b).

FIG. 4(a) shows a line-of-sight representation of a sharp line-of-sight. Further, FIG. 4(b) shows a line-of-sight representation (facial expression) called “eyes turn into dots.” In this way, even in the case of the same face image, the facial expression can be changed by the pseudo eyeball model 30.

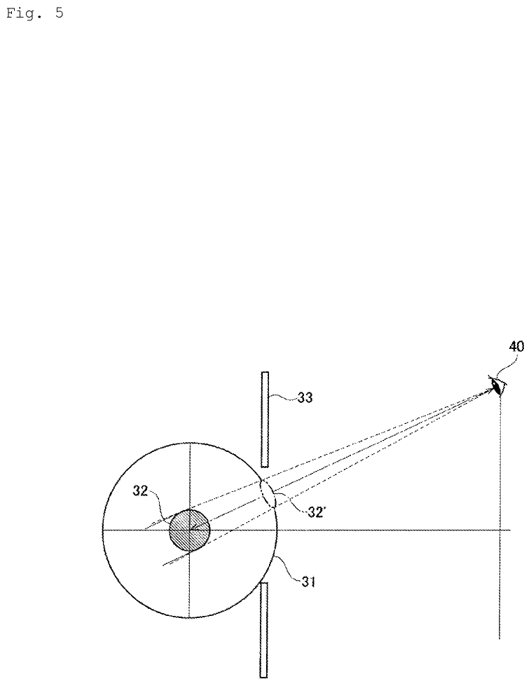

FIG. 5 is a diagram schematically showing another example of opening information indicating the eyelid 33. The eyelid 33 is not limited to the shape shown in FIG. 2 in which a portion of the annulus is removed. As shown in FIG. 5, the eyelid 33 may be configured in a planar shape in which a part of the virtual eyeball 31 and the pseudo pupil 32 can be seen. In short, the opening information indicating the eyelid 33 may be any information as long as the opening 34 can be formed. In other words, the pseudo eyeball model 30 may not include opening information indicating the opening 34 formed by the eyelid 33.

Further, a face image of a person may be drawn on the surface of the flat plate of the eyelid 33 shown in FIG. 5. In that case, the display device 20 only needs to display the pseudo eyeball image in accordance with the position of the opening of the eyelid 33 of the face image panel. In other words, the display device 20 does not need to display the face image.

(Display Device)

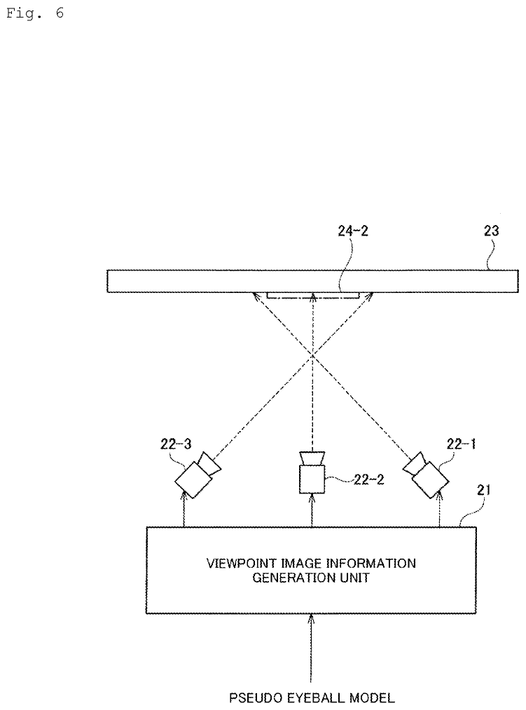

FIG. 6 is a diagram showing an example of a configuration of the display device 20 according to the embodiment. The display device 20 displays a pseudo eyeball image representing the pseudo eyeball which is different according to a viewpoint position of the observer based on the pseudo eyeball model 30.

As shown in FIG. 6, the display device 20 includes a viewpoint image information generation unit 21, a plurality of projection devices 22, and a screen 23. In this example, three projection devices 22-1, 22-2, and 22-3 are shown. It is sufficient that the number of projection devices 22 is two or more. The screen 23 shows an example of a reflection type. The viewpoint 40 of the observer, which is not shown, is on the opposite side to the screen 23 with the plurality of projection devices 22 interposed therebetween.

The viewpoint image information generation unit 21 converts a pseudo eyeball into three pieces of image information, that is, image information obtained by viewing the pseudo eyeball from the right side by the observer, image information obtained by viewing the pseudo eyeball from the front by the observer, and image information obtained by viewing the pseudo eyeball from the left side by the observer, based on the pseudo eyeball model 30 input from the pseudo eyeball model generation device 10.

At the same time, the viewpoint image information generation unit 21 generates image information in which the face of the person is viewed in each direction. However, the facial expression may be the same (for example, FIG. 4). The viewpoint image information generation unit 21 outputs three pieces of image information including the face of a person and a pseudo eyeball to the projection device 22.

The projection device 22-1 on the right side toward the screen 23 projects image information obtained by viewing the face of the person and the pseudo eyeball from the left side. The projection device 22-2 located in front of the screen 23 projects image information obtained by viewing the face of the person and the pseudo eyeball from the front. The projection device 22-3 on the left side toward the screen 23 projects image information obtained by viewing the face of the person and the pseudo eyeball from the right side.

Adjacent projection devices 22-1 and 22-2 and 22-2 and 22-3 project image information on the screen 23 in an overlapping manner. A projection surface 24-2 of the projection device 22-2 is shown on the surface of the screen 23. The projection device 22-1 projects a part of a projection surface 24-1 (not shown) on the left side of the projection surface 24-2 in an overlapping manner. The projection device 22-3 projects a part of a projection surface 24-3 (not shown) on the right side of the projection surface 24-2 in an overlapping manner.

The screen 23 is a screen in which the brightness of the displayed image is smoothly changed in accordance with the movement of the viewpoint. As a screen having such a characteristic, a “spatial imaging iris surface type screen” is known. The iris is a mechanism existing inside the projection device 22 and adjusts the amount of light corresponding to the diaphragm of the camera.

When the observer looks at the screen 23 while moving from the center of the central projection surface 24-2 to the projection surface 24-3, the observer perceives a stereoscopic image viewed by turning around the face of the person including the pseudo eyeball from the front to the right. Looking at the screen 23 while moving from the center of the central projection surface 24-2 to the projection surface 24-1, the observer perceives a stereoscopic image viewed by turning the face of the person including the pseudo eyeball from the front to the left. In other words, a stereoscopic image having motion parallax can be displayed.

The display device 20 does not necessarily require the above-mentioned motion parallax. A display device, such as a multi-viewpoint display having a small number of viewpoints, in which monocular images can be switched according to the position of the observer, may be used. The display of the face image of the person can be replaced with a panel on which the face is drawn, and thus the face image of the person may not be displayed.

As described above, the line-of-sight tracking system 100 according to the present embodiment is a line-of-sight tracking system including a pseudo eyeball model generation device 10 and a display device 20, in which the pseudo eyeball model generation device 10 generates a pseudo eyeball model 30 representing a pseudo eyeball with pseudo pupil information and virtual eyeball information indicating a virtual eyeball 31 when a type of line-of-sight tracking is one of with tracking, excessive tracking, weak tracking, and no tracking, the pseudo pupil information being obtained by moving a position of a pseudo pupil 32 back and forth when viewed from an observer with reference to a center of the virtual eyeball in association with the type of the line-of sight tracking and an intensity of the line-of-sight tracking, and the display device 20 displays a pseudo eyeball image representing the pseudo eyeball different according to a viewpoint position of the observer based on the pseudo eyeball model 30. In this way, the line-of-sight representation can be flexibly performed by the pseudo spectacle model 30.

Further, the display device 20 may display a different face image (facial expression) of a person in correspondence with the pseudo eyeball model 30. In this case, the viewpoint image information generation unit 21 uses the pseudo eyeball model 30 and emotion information (not shown) as inputs.

The emotion information is information indicating various emotions such as anger, joy, and sadness. The viewpoint image information generation unit 21 displays a different face image corresponding to the emotion information and a pseudo eyeball image based on the pseudo eyeball model 30.

In this way, the display device 20 may receive emotion information expressing the emotion as an input and display the pseudo eyeball corresponding to the pseudo eyeball model 30 and the facial expression corresponding to the emotion information. According to this, more rich line-of-sight representation can be provided.

(Diameter of Pseudo Pupil)

As described above, it has been described that the line-of-sight representation can be performed by moving the position of the pseudo pupil 32 back and forth when viewed from the observer with reference to the center of the virtual eyeball 31. Here, a guideline for the sizes of the virtual eyeball 31 and the pseudo pupil 32 will be described.

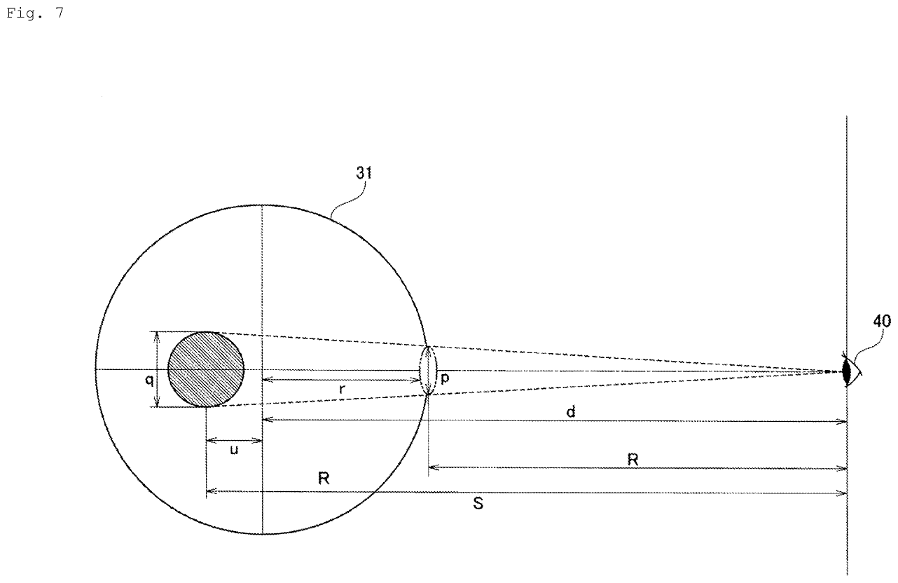

FIG. 7 is a diagram showing a relationship between the pseudo eyeball model 30 and the viewpoint 40 of the observer. In FIG. 7, q is the diameter of the pseudo pupil 32, p is the size of the pupil on the virtual eyeball, r is the radius of the virtual eyeball 31, u is the distance from the center of the virtual eyeball 31 to the center of the pseudo pupil 32, and d is the distance from the center of the virtual eyeball 31 to the viewpoint 40 of the observer.

The diameter q of the pseudo pupil 32 is calculated based on the following equation.

$$[ Math . 1 ]$$

$$q = \frac{pS}{R} = \frac{p ( d + u )}{d - r} \qquad ( 1 )$$

In this way, the pseudo eyeball model generation device 10 generates the diameter q of the pseudo pupil 32 by multiplying a ratio of a distance S between the center of the pseudo pupil 32 and the viewpoint 40 of the observer and a distance R between the surface of the virtual eyeball 31 on the observer side and the viewpoint 40 of the observer by the size p of the pupil on the virtual eyeball. Thereby, a pseudo eyeball model 30 capable of displaying a pseudo eyeball of an appropriate size can be generated.

The diameter q of the pseudo pupil 32 may be determined in consideration of the angle formed by the horizontal line passing through the center of the virtual eyeball 31 and the viewpoint 40 of the observer.

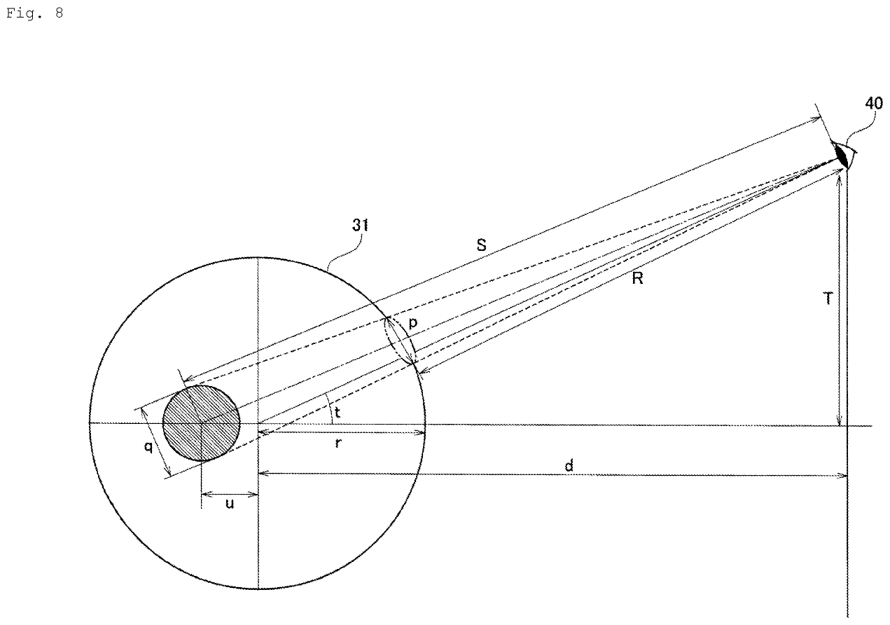

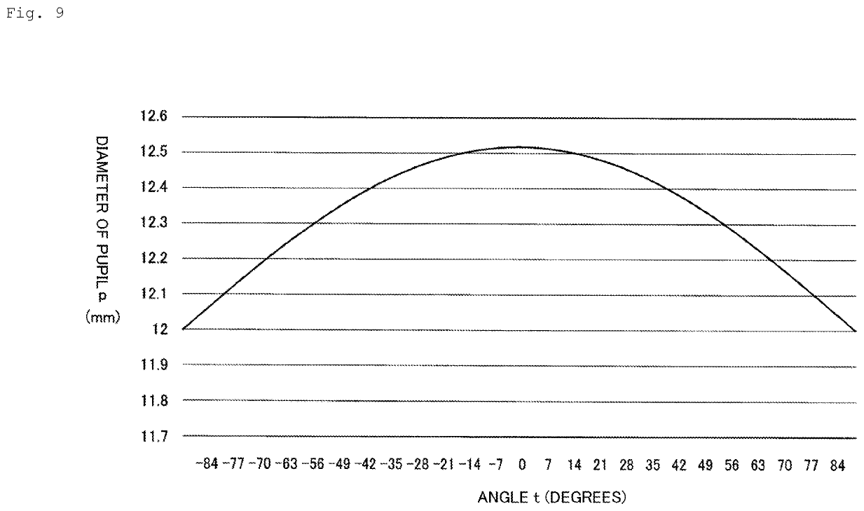

FIG. 8 is a diagram showing an angle t formed by the horizontal line passing through the center of the virtual eyeball 31 and the viewpoint 40 of the observer. FIG. 9 is a diagram showing an example of the relationship between the angle t (horizontal axis) and the diameter q (vertical axis) of the pseudo pupil 32.

As shown in FIG. 9, when the viewpoint 40 is in front of the pseudo pupil 32 (angle t=0 degrees), the diameter q of the pseudo pupil 32 is about 12.52 mm, which is the maximum. The diameter q of the pseudo pupil 32 may be maximized when the viewpoint 40 is in front of the pseudo pupil 32 and decreased regardless of whether the angle t changes to plus or minus.

In this way, the pseudo eyeball model generation device 10 may generate pseudo pupil information representing the pseudo pupil 32 in consideration of the angle formed by the horizontal line passing through the center of the virtual eyeball 31 and the viewpoint 40 of the observer. Thus, a pseudo eyeball model 30 capable of displaying a pseudo eyeball image closer to reality can be generated.

(Line-of-Sight Tracking Method)

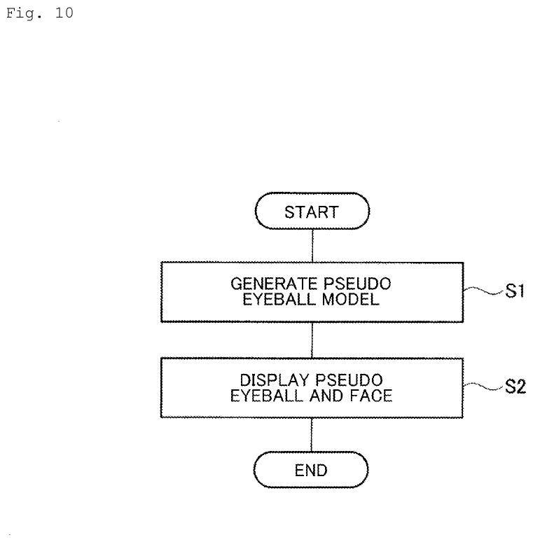

FIG. 10 is a flowchart showing a processing procedure of a line-of-sight tracking method performed by the line-of-sight tracking system 100 according to the present embodiment.

The pseudo eyeball model generation device 10 generates a pseudo eyeball model representing a pseudo eyeball with pseudo pupil information indicating the pseudo pupil 32 and virtual eyeball information indicating the virtual eyeball when a type of line-of-sight tracking is one of with tracking, excessive tracking, weak tracking, and no tracking, the pseudo pupil information indicating the pseudo pupil 32 being obtained by moving a position of a pseudo pupil back and forth when viewed from an observer with reference to a center of the virtual eyeball 31 in association with the type of the line-of sight tracking and an intensity of the line-of-sight tracking (step S1).

The display device 20 displays a pseudo eyeball image representing the pseudo eyeball which is different according to a viewpoint position of the observer based on the pseudo eyeball model (step S2). Thereby, the line-of-sight representation can be flexibly performed.

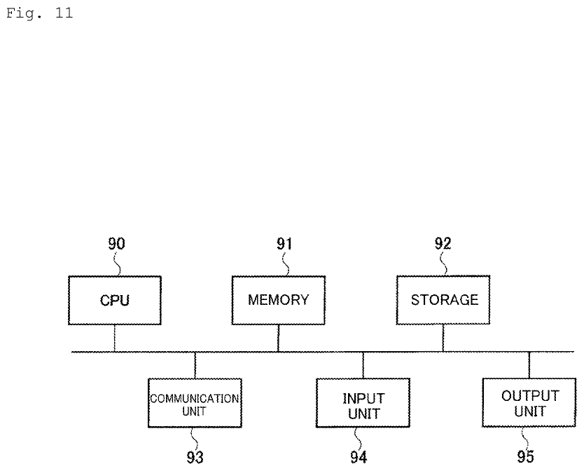

The line-of-sight tracking system 100 can be realized by a general-purpose computer system shown in FIG. 11. For example, in a general-purpose computer system including a CPU 90, a memory 91, a storage 92, a communication unit 93, an input unit 94, and an output unit 95, each function of the line-of-sight tracking system 100 is realized by the CPU 90 executing a predetermined program loaded on the memory 91. A predetermined program can be recorded on a computer-readable recording medium such as an HDD, an SSD, a USB memory, a CD-ROM, a DVD-ROM, or an MO and can also be distributed via a network.

The present invention is not limited to the above embodiment, and can be modified without departing from the scope of the gist of the invention. For example, although the screen 23 of the display device 20 has been described with reference to an example of a reflection type, the present invention is not limited to this example. The screen 23 may be of a transmission type. In the case of a transmission type screen, an observer observes the pseudo eyeball with light transmitted through the screen.

Although the information on the “type of line-of-sight tracking” and the “intensity of line-of-sight tracking” has been described with reference to an example in which the information is input from the outside, the present invention is not limited to this example. For example, a line-of-sight generation unit that generates information on the “type of line-of-sight tracking” and the “intensity of line-of-sight tracking” along a scenario may be provided.

In this manner, the present invention includes various embodiments etc., not described herein, as a matter of course. Thus, the technical scope of the present invention is only defined by invention specifying matters in the claims that are appropriate from the above description.

### REFERENCE SIGNS LIST

10 Pseudo eyeball model generation device
   20 Display device
   21 Viewpoint image information generation unit
   22-1, 22-2, 22-3 Projection device
   23 Screen
   30 Pseudo eyeball model
   31 Virtual eyeball
   32 Pseudo pupil
   33 Eyelid
   40 Viewpoint of observer
   100 Line-of-sight tracking system

1. A line-of-sight tracking system comprising:
a display device, and
one or more processors configured to:
generate a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking, and
the display device is configured to display a pseudo eyeball image representing the pseudo eyeball which is different according to a viewpoint position of the observer based on the pseudo eyeball model.

2. The line-of-sight tracking system according to claim 1, wherein the one or more processors are configured to determine a diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

3. The line-of-sight tracking system according to claim 2, wherein the one or more processors are configured to determine the diameter of the pseudo pupil in consideration of an angle formed by a horizontal line passing through the center of the virtual eyeball and the viewpoint.

4. The line-of-sight tracking system according to claim 3, wherein the display device is configured to receive emotion information indicating an emotion as an input, and display the pseudo eyeball and a facial expression corresponding to the emotion information.

5. A line-of-sight tracking method performed by a line-of-sight tracking system including one or more processors and a display device, the method comprising:
generating, by the one or more processors, a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking; and
displaying, by the display device, a pseudo eyeball image representing the pseudo eyeball which is different according to a viewpoint position of the observer based on the pseudo eyeball model.

6. A program for causing a computer to function as the line-of-sight tracking system according to claim 1.

7. A non-transitory computer-readable medium storing software comprising instructions executable by one or more computers which, upon such execution, cause the one or more computers to perform operations comprising:
generating, by one or more processors, a pseudo eyeball model representing a pseudo eyeball with pseudo pupil information and virtual eyeball information indicating a virtual eyeball when a type of line-of-sight tracking is one of with tracking, excessive tracking, weak tracking, and no tracking, the pseudo pupil information being obtained by moving a position of a pseudo pupil back and forth when viewed from an observer with reference to a center of the virtual eyeball in association with the type of the line-of sight tracking and an intensity of the line-of-sight tracking; and
displaying, by a display device, a pseudo eyeball image representing the pseudo eyeball which is different according to a viewpoint position of the observer based on the pseudo eyeball model.

8. The line-of sight tracking method according to claim 5, comprising:
determining, by the one or more processors, a diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

9. The line-of sight tracking method according to claim 8, comprising:
determining, by the one or more processors, the diameter of the pseudo pupil in consideration of an angle formed by a horizontal line passing through the center of the virtual eyeball and the viewpoint.

10. The line-of sight tracking method according to claim 9, comprising:
receiving, by the one or more processors, emotion information indicating an emotion as an input; and
displaying, by the display device, the pseudo eyeball and a facial expression corresponding to the emotion information.

11. The non-transitory computer-readable medium according to claim 7, comprising:
determining, by the one or more processors, a diameter of the pseudo pupil based on a ratio of a distance between a viewpoint of the observer located in front of the pseudo eyeball and a center of the pseudo pupil to a distance between the viewpoint and a surface of the virtual eyeball on a side of the observer.

12. The non-transitory computer-readable medium according to claim 11, comprising:
determining, by the one or more processors, the diameter of the pseudo pupil in consideration of an angle formed by a horizontal line passing through the center of the virtual eyeball and the viewpoint.

13. The non-transitory computer-readable medium according to claim 12, comprising:
receiving, by the one or more processors, emotion information indicating an emotion as an input; and
displaying, by the display device, the pseudo eyeball and a facial expression corresponding to the emotion information.
